(19) United States
(12) Patent Application Publication
(10) Pub. No.: US 2011/0231093 A1
(43) Pub. Date: Sep. 22, 2011

(54) MAP INFORMATION PROCESSING DEVICE

(75) Inventors: Tomoya Ikeuchi, Tokyo (JP); Makoto Mikuriya, Tokyo (JP); Masaharu Umezu, Tokyo (JP); Yasushi Kodaka, Tokyo (JP); Kosei Uchino, Tokyo (JP)

(73) Assignee: MITSUBISHI ELECTRIC CORPORATION, Tokyo (JP)

(21) Appl. No.: 13/123,457

(22) PCT Filed: Nov. 25, 2009
(86) PCT No.: PCT/JP2009/006349

§ 371 Date: Apr. 8, 2011

(30) Foreign Application Priority Data
Feb. 16, 2009 (JP) 2009-032713

(51) Int. Cl. G01C 21/26

(52) U.S. Cl. 701/208

(57) ABSTRACT

A map information processing device includes: a map information storage unit 23 for storing map information; a sensor information input unit 22 for inputting sensor information used for calculation of a current position; a navigation processing unit 25 for calculating the current position by using the map information read from the map information storage unit, and the sensor information inputted from the sensor information input unit, and for, when determining, from the above-mentioned calculated current position, that a vehicle has entered a tunnel shown by the above-mentioned read map information, calculating the number of tunnels excising forwardly and continuously at intervals of a predetermined distance or less from the above-mentioned tunnel to generate a map image about a map including the above-mentioned calculated number of tunnels; and an output control unit 26 for outputting the map image generated by the navigation processing unit 25.

### FIELD OF THE INVENTION

The present invention relates to a map information processing device which is applied to a navigation device, for example, and which processes map information. More particularly, it relates to a technology of presenting information about tunnel exits while a vehicle is traveling through a plurality of continuous tunnels.

### BACKGROUND OF THE INVENTION

A conventional navigation device displays a tunnel in a form different from that in which roads are displayed on a map while the vehicle equipped with the navigation device is traveling through the tunnel. However, because the remaining distance of the tunnel is not displayed on the map, the driver may have an uncertain, insecure feeling resulting from being unable to acquire information about the distance to the tunnel exit while the vehicle is traveling through a long tunnel.

As a technology of outputting information about a tunnel, patent reference 1 discloses a navigation device that can notify the driver about a relationship between the current position and an evacuation route promptly when the driver encounters an accident or the like in a tunnel. When the driver encounters an accident or the like in a tunnel, this conventional navigation device detects the emergency situation, such as an accident, according to the user's command or automatically, and informs the relationship between the current position and an emergency exit to the user.

### RELATED ART DOCUMENT

### Patent Reference

Patent reference 1: JP, 2008-96346, A

### SUMMARY OF THE INVENTION

However, because the navigation device disclosed by above-mentioned patent reference 1 does not present any information about tunnel exits to the driver during normal travel of the vehicle through any tunnel, the navigation device cannot remove an uncertain, insecure feeling, as mentioned above, which the driver may have.

The present invention is made in order to solve the above-mentioned problem, and it is therefore an object of the present invention to provide a map information processing device that can remove an uncertain, insecure feeling which the driver may have when driving through a tunnel.

In order to solve the above-mentioned problem, in accordance with the present invention, there is provided a map information processing device including: a map information storage unit for storing map information; a sensor information input unit for inputting sensor information used for calculation of a current position; a navigation processing unit for calculating the current position by using the map information read from the map information storage unit, and the sensor information inputted from the sensor information input unit, and for, when determining, from the above-mentioned calculated current position, that a vehicle has entered a tunnel shown by the above-mentioned read map information, calculating the number of tunnels excising forwardly and continuously at intervals of a predetermined distance or less from the above-mentioned tunnel to generate a map image about a map including the above-mentioned calculated number of tunnels; and an output control unit for outputting the map image generated by the navigation processing unit.

Because the map information processing device according to the present invention is constructed in such a way as to, when the vehicle has entered a tunnel, present the number of tunnels excising forwardly and continuously at intervals of the predetermined distance or less from the tunnel to the driver, the psychological burden on the driver resulting from being unable to acquire any information about tunnel exits can be reduced.

### BRIEF DESCRIPTION OF THE FIGURES

FIG. 1 is a block diagram showing the structure of a map information processing device according to Embodiment 1 of the present invention;

FIG. 2 is a flow chart showing tunnel display processing carried out by the map information processing device in accordance with Embodiment 1 of the present invention;

FIG. 3 is a view showing an example of a screen displayed through the tunnel display processing carried out by the map information processing device in accordance with Embodiment 1 of the present invention;

FIG. 4 is a flow chart showing tunnel display processing carried out by a map information processing device in accordance with Embodiment 2 of the present invention;

FIG. 5 is a view showing an example of a screen displayed through the tunnel display processing carried out by the map information processing device in accordance with Embodiment 2 of the present invention;

FIG. 6 is a flow chart showing tunnel display processing carried out by a map information processing device in accordance with Embodiment 3 of the present invention;

FIG. 7 is a view showing an example of a screen displayed through the tunnel display processing carried out by the map information processing device in accordance with Embodiment 3 of the present invention;

FIG. 8 is a flow chart showing tunnel display processing carried out by a map information processing device in accordance with Embodiment 4 of the present invention;

FIG. 9 is a view showing an example of a screen displayed through the tunnel display processing carried out by the map information processing device in accordance with Embodiment 4 of the present invention;

FIG. 10 is a flow chart showing tunnel display processing carried out by a map information processing device in accordance with Embodiment 5 of the present invention; and

FIG. 11 is a view showing an example of a screen displayed through the tunnel display processing carried out by the map information processing device in accordance with Embodiment 5 of the present invention.

### EMBODIMENTS OF THE INVENTION

Hereafter, in order to explain this invention in greater detail, the preferred embodiments of the present invention will be described with reference to the accompanying drawings. Embodiment 1.

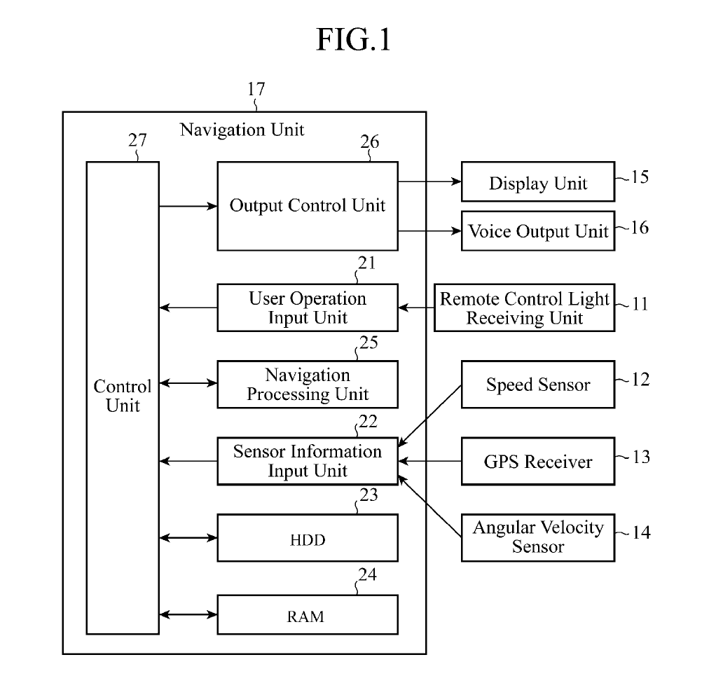

FIG. 1 is a block diagram showing the structure of a map information processing device in accordance with Embodiment 1 of the present invention. Hereafter, an example in which the map information processing device is applied to a navigation device will be explained. This map information processing device is provided with a remote controller (abbreviated to as a “remote control” from here on) light receiving unit 11, a speed sensor 12, a GPS (Global Positioning System) receiver 13, an angular velocity sensor 14, a display unit 15, a voice output unit 16, and a navigation unit 17.

The remote control light receiving unit 11 receives a signal (an infrared ray or a radio wave) for commanding the navigation device to perform an operation, which is sent from a wireless remote control (not shown) operated by a user, and sends the signal received thereby to the navigation unit 17 as an operation signal.

The speed sensor 12 measures the speed of itself moving, and informs the speed to the navigation unit 17 as a speed signal. The GPS receiver 13 receives radio waves transmitted from GPS satellites, and sends the radio waves to the navigation unit 17 as GPS signals. The angular velocity sensor 14 measures a direction change of itself, and informs the direction change to the navigation unit 17 as a heading signal.

The display unit 15 is comprised of a liquid crystal display, for example, and displays a map image, a recommended route, and information, such as the number of continuous tunnels or the remaining distance of a tunnel, according to an image signal sent thereto from the navigation unit 17.

The voice output unit 16 is comprised of a speaker, for example. According to a voice signal sent thereto from the navigation unit 17, the voice output unit outputs a voice providing guidance to a destination according to a recommended route and a voice notifying the number of continuous tunnels or the remaining distance of a tunnel, and also outputs a voice providing various pieces of information included in map information.

The navigation unit 17 is provided with a user operation input unit 21, a sensor information input unit 22, an HDD (Hard Disk Drive) 23, a RAM (Random Access Memory) 24, a navigation processing unit 25, an output control unit 26, and a control unit 27.

The user operation input unit 21 receives the operation signal sent thereto from the remote control light receiving unit 11, and sends the operation signal to the control unit 27. The sensor information input unit 22 receives the vehicle speed signal sent thereto from the speed sensor 12, the GPS signals sent thereto from the GPS receiver 13, and the heading signal sent thereto from the angular velocity sensor 14, and sends those signals to the control unit 27 as sensor information.

The HDD 23 corresponds to a map information storage unit according to the present invention, and stores map information. The map information is represented by a graph structure in which each intersection is defined as a node and each road between intersections is defined as a link. A tunnel flag showing whether or not the road is a tunnel is added to each link. If the road is a tunnel, the tunnel flag is set to “1”; otherwise, the tunnel flag is set to “0”. Furthermore, travel-enabled direction information showing directions in which vehicles can travel is added to each link. The map information stored in this HDD 23 can be read by the control unit 27.

The map information storage unit according to the present invention is not limited to the HDD. For example, the map information storage unit can be constructed of a disk drive device that reads map information stored in a recording medium, such as a DVD (Digital Versatile Disk) or a CD (Compact Disc).

The RAM 24 temporarily stores data used for various processes. For example, the map information read from the HDD 23 is written into the RAM 24 via the control unit 27. Furthermore, the map information stored in the RAM 24 can be read by the navigation processing unit 25 via the control unit 27.

The navigation processing unit 25 performs one of various processes to implement a navigation function according to a command from the control unit 27. For example, the navigation processing unit 25 performs a process for implementing a current position calculating function of detecting a current point by using the sensor information sent thereto from the sensor information input unit 22 via the control unit 27, and calculating a position on the road where this detected current point exists (simply referred to as a “current position” from here on) with reference to the map information read from the HDD 23 via the control unit 27, a map display function of creating a map image about a map of an area in the vicinity of the current position or an area including an arbitrary point, which is to be displayed on the display unit 15, a route determining function of determining a recommended route from the current position to an arbitrary point or between two arbitrary points, a route guiding function of providing guidance about a destination, a right or left turn or the like according to the recommended route determined by the route determining function, or the like. Each of these functions is implemented with reference to the map information stored in the HDD 23. The process results obtained by this navigation processing unit 25 are sent to the control unit 27.

The output control unit 26 generates an image signal according to the results of the navigation process sent thereto via the control unit 27 from the navigation processing unit 25 and sends the image signal to the display unit 15, and also generates a voice signal according to the results of the navigation process and sends this voice signal to the voice output unit 16.

The control unit 27 controls the whole of the navigation unit 17 by controlling transmission and reception of data among the user operation input unit 21, the sensor information input unit 22, the HDD 23, the RAM 24, the navigation processing unit 25, and the output control unit 26.

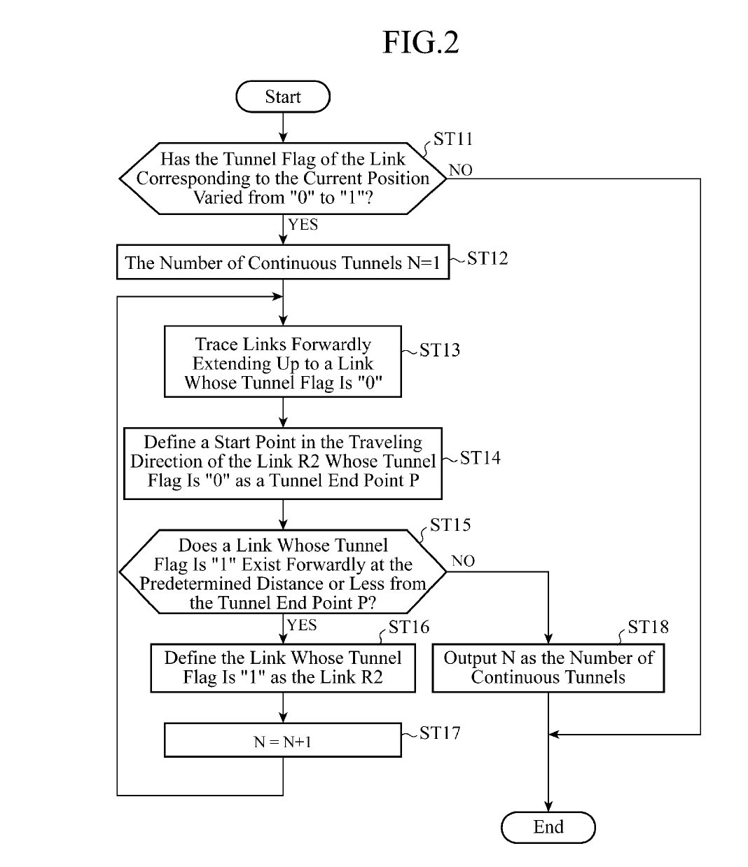

Next, the operation of the map information processing device in accordance with Embodiment 1 constructed as mentioned above will be explained with reference to a flow chart shown in FIG. 2, focusing on tunnel display processing of displaying information about tunnel exits.

In the tunnel display processing, whether the tunnel flag of the link corresponding to the current position has varied from “0” to “1” is checked to see first (step ST11). More specifically, the navigation processing unit 25 calculates the current position by using the current position calculation function to check to see whether or not the tunnel flag added to the link where this calculated current position exists is “1” and the tunnel flag added to the previous link along which the vehicle was traveling immediately before entering the current link is “0”, that is, whether the tunnel flag has varied from “0” to “1”. When, in this step ST11, determining that the tunnel flag has not varied from “0” to “1”, the navigation processing unit recognizes that the vehicle has not entered a tunnel and ends the tunnel display processing.

In contrast, when it is determined, in step ST11, that the tunnel flag has varied from “0” to “1”, it is recognized that the vehicle has entered a tunnel and the number of continuous tunnels N is then initialized to “1” (step ST12). More specifically, the navigation processing unit 25 initializes a number-of-tunnels counter (not shown in the figure) for counting the number of tunnels continuously existing at intervals of a predetermined distance or less to “1”. In this case, the predetermined distance can be determined arbitrarily.

Links forwardly extending up to a link whose tunnel flag is “0” are then traced (step ST13). More specifically, the navigation processing unit 25 performs a process of tracing links existing forwardly from the link where the current position exists one by one with reference to the map information read from the HDD 23 via the control unit 27 until reaching a link whose tunnel flag is “0”.

A start point in the traveling direction of the link R2 whose tunnel flag is “0” is then defined as a tunnel end point P (step ST14). More specifically, the navigation processing unit 25 stores the start point of the link which the navigation processing unit has reached in the process of step ST13 and whose tunnel flag is “0” as the tunnel end point P.

Whether a link whose tunnel flag is “1” exists forwardly at the predetermined distance or less from the tunnel end point P is then checked to see (step ST15). More specifically, the navigation processing unit 25 checks to see whether a link whose tunnel flag is “1” exists forwardly at the predetermined distance or less from the tunnel end point P determined in step ST14 with reference to the map information read from the HDD 23 via the control unit 27.

When it is determined, in this step ST15, that a link whose tunnel flag is “1” exists forwardly at the predetermined distance or less from the tunnel end point P, it is recognized that a tunnel exists continuously at the predetermined distance or less from the tunnel end point, and the link whose tunnel flag is “1” is defined as the link R2 (step ST16). More specifically, the navigation processing unit 25 defines the link whose tunnel flag is “1” existing forwardly at the predetermined distance or less from the tunnel end point P as the link R2.

The number of continuous tunnels N is then incremented (+1) (step ST17). More specifically, the navigation processing unit 25 adds “1” to the count value of the number-of-tunnels counter. After that, the navigation device returns the sequence to step ST13 and then repeats the above-mentioned processing.

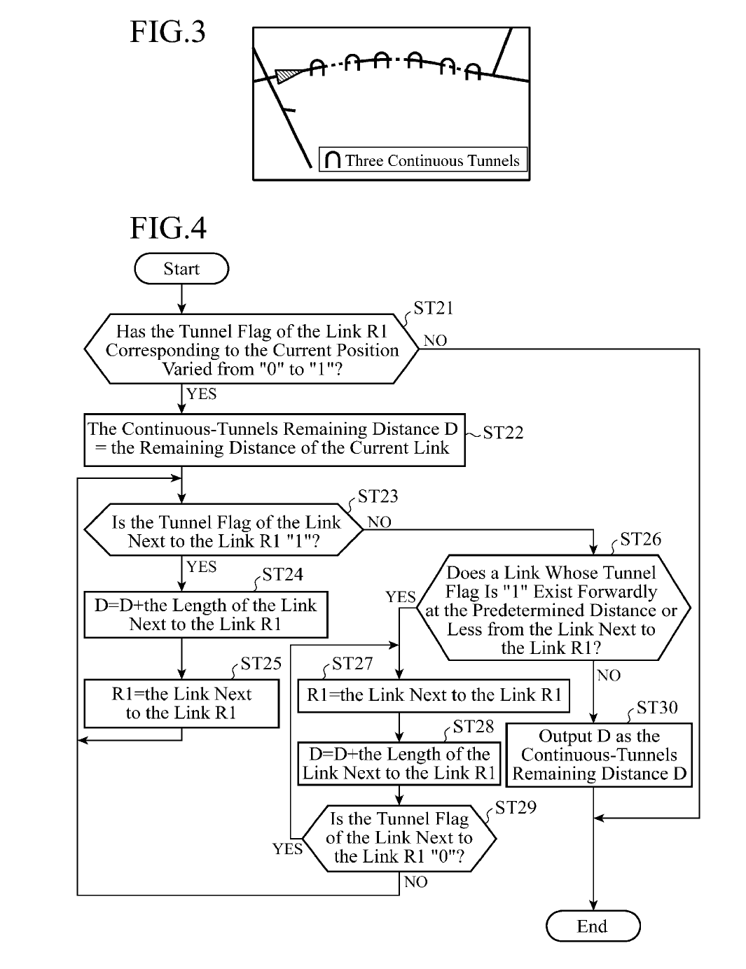

In contrast, when it is determined, in above-mentioned step ST15, that no link whose tunnel flag is “1” exists forwardly at the predetermined distance or less from the tunnel end point P, it is recognized that no tunnel exists continuously at the predetermined distance or less from the tunnel end point, and, and N is outputted as the number of continuous tunnels (step ST18). More specifically, the navigation processing unit 25 defines the number-of-tunnels counter at that time as the number of continuous tunnels N, and informs this number to the output control unit 26 via the control unit 27. The output control unit 26 generates an image in which the number of continuous tunnels N received from the control unit 27 is superimposed onto a map and sends the image to the display unit 15 as an image signal. As a result, as shown in FIG. 3, for example, the number of tunnels continuously existing at intervals of the predetermined distance or less is displayed on a part of the screen of the display unit 15. FIG. 3 shows a case where three tunnels continuously exist at intervals of the predetermined distance or less with a character string: “Three continuous tunnels”.

The output control unit 26 can be constructed in such a way as to further generate a voice signal for saying the number of tunnels continuously existing at intervals of the predetermined distance or less according to the number of continuous tunnels N received from the control unit 27 and send the voice signal to the voice output unit 16. As a result, the number of tunnels continuously existing at intervals of the predetermined distance or less is outputted by voice from the voice output unit 16.

As explained above, because when the vehicle has entered a tunnel, the map information processing device in accordance with Embodiment 1 of the present invention presents the number of tunnels continuously existing at intervals of the predetermined distance or less to the driver, the psychological burden on the driver resulting from being unable to acquire any information about tunnel exits can be reduced.

The map information processing device can be alternatively constructed in such a way as to calculate the number of continuous tunnels N when detecting a point at which the tunnel flag varies from “0” to “1” in an area at a predetermined distance before the tunnels. In this case, the map information processing device can be constructed in such a way as to change the predetermined distance according to the type of the road, e.g. whether or not the road is a highway.

### Embodiment 2

A map information processing device in accordance with Embodiment 2 of the present invention is constructed in such a way as to, when tunnels exist continuously at intervals of a predetermined distance or less, display the distance to the exit of the last one of the tunnels. The map information processing device in accordance with Embodiment 2 of the present invention has the same structure as that in accordance with Embodiment 1 shown in FIG. 1.

Next, the operation of the map information processing device in accordance with Embodiment 2 will be explained. In tunnel display processing, whether the tunnel flag of a link R1 corresponding to the current position has varied from “0” to “1” is checked to see first (step ST21). The process in this step ST21 is the same as that in step ST11 shown in FIG. 2. When it is determined, in this step ST21, that the tunnel flag has not varied from “0” to “1”, it is recognized that the vehicle has not entered a tunnel and the tunnel display processing is ended.

In contrast, when it is determined, in step ST21, that the tunnel flag has varied from “0” to “1”, it is recognized that the vehicle has entered a tunnel and the remaining distance of the current link is then defined as a continuous-tunnels remaining distance D (step ST22). More specifically, a navigation processing unit 25 calculates the current position by using a current position calculation function, calculates the remaining distance of the link where this calculated current position exists, i.e., the distance to the next node which exists in the traveling direction, and sets this distance to a tunnel distance counter (not shown) as an initial value of the continuous-tunnels remaining distance D.

Whether or not the tunnel flag of the link next to the link R1 is “1” is then checked to see (step ST23). More specifically, the navigation processing unit 25 checks to see whether the tunnel flag added to the link next to the link R1 where the current position exists is “1” with reference to the map information read from an HDD 23 via a control unit 27.

When it is determined, in this step ST23, that the tunnel flag of the link next to the link R1 is “1”, it is recognized that the next link is also a tunnel, and the link length of the next link is added to the current continuous-tunnels remaining distance D and this addition result is defined as a new continuous-tunnels remaining distance D (step ST24). More specifically, the navigation processing unit 25 calculates the new continuous-tunnels remaining distance D by adding the link length of the next link to the count value of the tunnel distance counter.

The link next to the link R1 is then defined as a new link R1 (step ST25). More specifically, the navigation processing unit 25, in step ST23, defines the link to which the navigation processing unit has determined “1” is added as its tunnel flag as the new link R1. After that, the navigation device returns the sequence to step ST23 and then repeats the above-mentioned processing.

When it is determined, in above-mentioned step ST23, that the tunnel flag of the link next to the link R1 is not “1”, i.e. “0”, it is recognized that the next link is not a tunnel, and whether a link whose tunnel flag is “1” exists forwardly at the predetermined distance or less from the link next to the link R1 is then checked to see (step ST26). More specifically, the navigation processing unit 25 checks to see whether a link whose tunnel flag is “1” exists forwardly at the predetermined distance or less from the link next to the link R1 with reference to the map information read from the HDD 23 via the control unit 27.

When it is determined, in this step ST26, that a link whose tunnel flag is “1” exists forwardly at the predetermined distance or less from the link next to the link R1, it is recognized that a tunnel exists continuously at intervals of the predetermined distance or less, and this link next to the link R1 is defined as a new link R1 (step ST27). The process in this step ST27 is the same as that in above-mentioned step ST25. The link length of the next link is then added to the current continuous-tunnels remaining distance D, and the addition result is defined as a new continuous-tunnels remaining distance D (step ST28). The process in this step ST28 is the same as that in above-mentioned step ST24.

Whether the tunnel flag of the link next to the link R1 is “0” is then checked to see (step ST29). More specifically, the navigation processing unit 25 checks to see whether the tunnel flag added to the link next to the link R1 is “0” with reference to the map information read from the HDD 23 via the control unit 27. When it is determined, in this step ST29, that the tunnel flag of the link next to the link R1 is “0”, the navigation device returns the sequence to step ST27 and repeats the above-mentioned processing. In contrast, when it is determined, in step ST29, that the tunnel flag of the link next to the link R1 is not “0”, the navigation device returns the sequence to step ST23 and repeats the above-mentioned processing.

When it is determined, in above-mentioned step ST26, that no link whose tunnel flag is “1” exists forwardly at the predetermined distance or less from the link next to the link R1, it is recognized that no more tunnel exists continuously at intervals of the predetermined distance or less, and D is outputted as the continuous-tunnels remaining distance (step ST30). More specifically, the navigation processing unit 25 defines the count value of the tunnel distance counter at that time as the continuous-tunnels remaining distance D, and informs this distance to an output control unit 26 via the control unit 27. The output control unit 26 generates an image in which the continuous-tunnels remaining distance D received from the control unit 27 is superimposed onto a map, and sends the image to a display unit 15 as an image signal. As a result, as shown in FIG. 5, for example, the remaining distance to the exit of the last tunnel among the tunnels existing continuously at intervals of the predetermined distance or less is displayed on a part of the screen of the display unit 15. FIG. 5 shows the distance to the exit of the last one of three tunnels with a character string “860 m remaining to the exit of the last one of continuous tunnels”.

The output control unit 26 can be constructed in such a way as to further generate a voice signal for saying the remaining distance to the exit of the last one of the tunnels existing continuously at intervals of the predetermined distance or less according to the continuous-tunnels remaining distance D received from the control unit 27 and send the voice signal to a voice output unit 16. Accordingly, the remaining distance to the exit of the last one of the tunnels existing continuously at intervals of the predetermined distance or less is outputted by voice from the voice output unit 16.

As explained above, because when the vehicle has entered a tunnel, the map information processing device in accordance with Embodiment 2 of the present invention displays the distance to the exit of the last one of tunnels existing continuously at intervals of the predetermined distance or less, the psychological burden on the driver resulting from being unable to acquire any information about tunnel exits can be reduced.

Although the map information processing device in accordance with Embodiment 2 of the present invention is constructed in such a way as to display the distance to the exit of the last one of tunnels existing continuously at intervals of the predetermined distance or less, the map information processing device can be alternatively constructed in such a way as to output the number of tunnels, like the map information processing device in accordance with Embodiment 1, simultaneously with this distance.

### Embodiment 3

A map information processing device in accordance with Embodiment 3 of the present invention is constructed in such a way as to display the distance to the exit of each of all points at each of which a tunnel flag varies from “1” to “0”, i.e. all tunnels existing continuously at intervals of a predetermined distance or less. The map information processing device in accordance with Embodiment 3 of the present invention has the same structure as that in accordance with Embodiment 1 shown in FIG. 1.

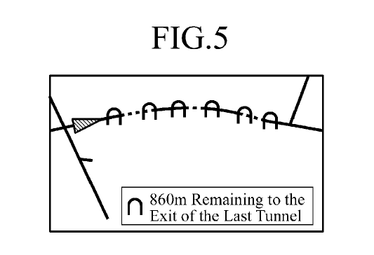

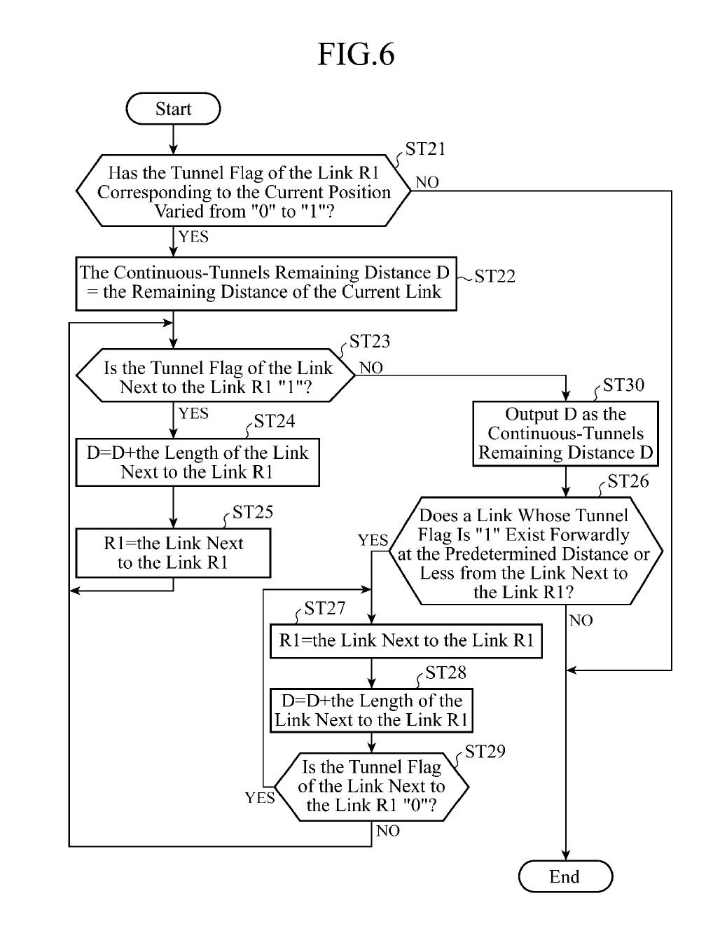

Next, the operation of the map information processing device in accordance with Embodiment 3 will be explained with reference to a flow chart shown in FIG. 6, focusing on tunnel display processing of displaying information about tunnel exits. Steps in which the same processes as those of the tunnel display processing carried out by the map information processing device in accordance with Embodiment 2 shown in the flow chart of FIG. 4 or like processes are respectively carried out are designated by the same reference characters as those shown in FIG. 4, and the explanation of the steps will be simplified.

In the tunnel display processing, whether the tunnel flag of a link R1 corresponding to the current position has varied from “0” to “1” is checked to see first (step ST21). When it is determined, in this step ST21, that the tunnel flag has not varied from “0” to “1”, it is recognized that the vehicle has not entered a tunnel and the tunnel display processing is ended.

In contrast, when it is determined, in step ST21, that the tunnel flag has varied from “0” to “1”, it is recognized that the vehicle has entered a tunnel and the remaining distance of the current link is then defined as a continuous-tunnels remaining distance D (step ST22). Whether or not the tunnel flag of the link next to the link R1 is “1” is then checked to see (step ST23).

When it is determined, in this step ST23, that the tunnel flag of the link next to the link R1 is “1”, it is recognized that the next link is also a tunnel, and the link length of the next link is added to the current continuous-tunnels remaining distance D and this addition result is defined as a new continuous-tunnels remaining distance D (step ST24). The link next to the link R1 is then defined as a new link R1 (step ST25). After that, the navigation device returns the sequence to step ST23 and then repeats the above-mentioned processing.

When it is determined, in above-mentioned step ST23, that the tunnel flag of the link next to the link R1 is not “1”, i.e. “0”, it is recognized that the next link is not a tunnel, and D is then outputted as the continuous-tunnels remaining distance (step ST30). More specifically, the navigation processing unit 25 defines the count value of the tunnel distance counter at that time as the continuous-tunnels remaining distance D, and informs this distance to an output control unit 26 via a control unit 27. The output control unit 26 generates an image in which the continuous-tunnels remaining distance D received from the control unit 27 is superimposed onto a map, and sends the image to a display unit 15 as an image signal. As a result, the remaining distance to the exit of one of the tunnels existing continuously at intervals of the predetermined distance or less is displayed on a part of the screen of the display unit 15.

Whether a link whose tunnel flag is “1” exists forwardly at the predetermined distance or less from the link next to the link R1 is then checked to see (step ST26). When it is determined, in this step ST26, that a link whose tunnel flag is “1” exists forwardly at the predetermined distance or less from the link next to the link R1, it is recognized that a tunnel exists continuously at intervals of the predetermined distance or less, and this link next to the link R1 is defined as a new link R1 (step ST27). The process in this step ST27 is the same as that in above-mentioned step ST25. The link length of the next link is then added to the current continuous-tunnels remaining distance D and this addition result is defined as a new continuous-tunnels remaining distance D (step ST28). The process in this step ST28 is the same as that in above-mentioned step ST24.

Whether the tunnel flag of the link next to the link R1 is “0” is then checked to see (step ST29). When it is determined, in this step ST29, that the tunnel flag of the link next to the link R1 is “0”, the navigation device returns the sequence to step ST27 and repeats the above-mentioned processing. In contrast, when it is determined, in step ST29, that the tunnel flag of the link next to the link R1 is not “0”, the navigation device returns the sequence to step ST23 and repeats the above-mentioned processing.

When it is determined, in above-mentioned step ST26, that no link whose tunnel flag is “1” exists forwardly at the predetermined distance or less from the link next to the link R1, it is recognized that no more tunnel exists continuously at intervals of the predetermined distance or less, and the tunnel display processing is ended.

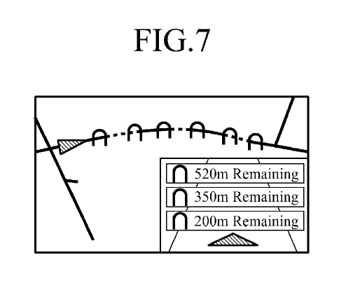

Through the above-mentioned processing, when a plurality of tunnels exist continuously at intervals of the predetermined distances or less, the distance to the exit of each of the tunnels is displayed on a part of the screen of the display unit 15, as shown in FIG. 7, for example. FIG. 7 shows an example in which the distances to the exits of three tunnels are shown by character strings: “200 m remaining”, “350 m remaining”, and “520 m remaining”, respectively. The navigation device can be constructed in such a way as to output, by voice, the remaining distance to the exit of each of the tunnels existing continuously at intervals of the predetermined distances or less in addition to the above-mentioned display. In this case, the output control unit 26 generates a voice signal for saying the remaining distance to the exit of one of the tunnels existing continuously at intervals of the predetermined distances or less according to the continuous-tunnels remaining distance D received from the control unit 27, and sends the voice signal to a voice output unit 16.

As explained above, because when the vehicle has entered a tunnel, the map information processing device in accordance with Embodiment 3 of the present invention displays the distance to the exit of each of tunnels existing continuously at intervals of the predetermined distance or less, the psychological burden on the driver resulting from being unable to acquire any information about tunnel exits can be reduced.

Although the map information processing device in accordance with Embodiment 3 is constructed in such a way as to output the distance to the exit of each of tunnels existing continuously at intervals of the predetermined distance or less, the map information processing device can be alternatively constructed in such a way as to output only the distance calculated in the loop of steps ST23 to ST25, and, in this case, can output only the length of each of the tunnels excluding the length of each road section except the tunnels.

### Embodiment 4

A map information processing device in accordance with Embodiment 4 of the present invention is constructed in such a way as to display the distance to the exit of each tunnel until the number of points at each of which a tunnel flag varies from “1” to “0” reaches a predetermined number. The map information processing device in accordance with Embodiment 4 of the present invention has the same structure as that in accordance with Embodiment 1 shown in FIG. 1.

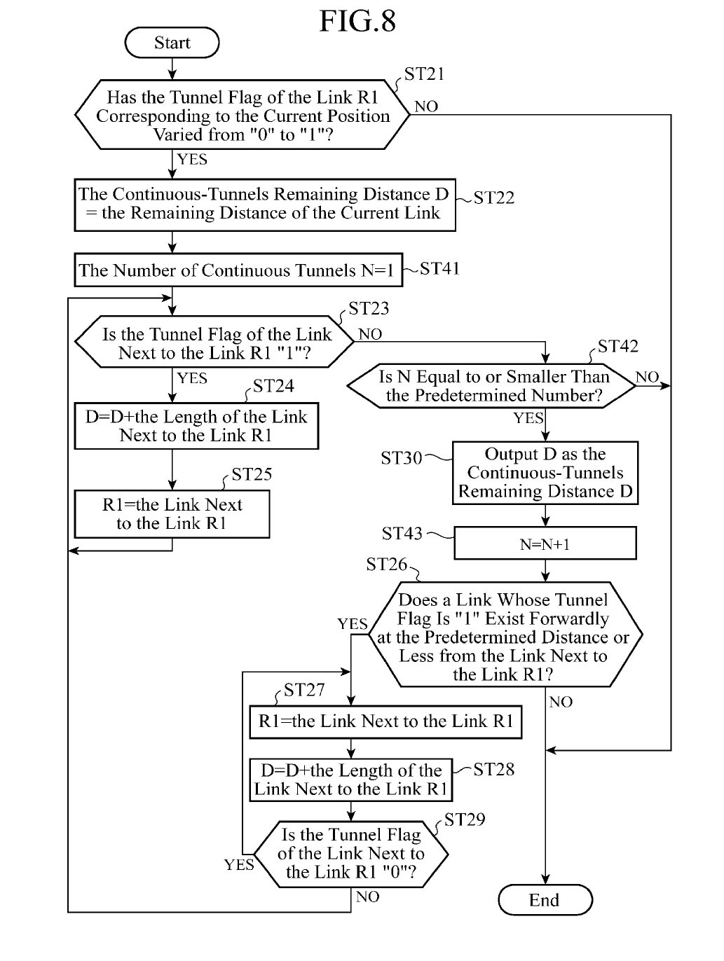

Next, the operation of the map information processing device in accordance with Embodiment 4 will be explained with reference to a flow chart shown in FIG. 8, focusing on tunnel display processing of displaying information about tunnel exits. Steps in which the same processes as those of the tunnel display processing carried out by the map information processing device in accordance with Embodiment 2 shown in the flow chart of FIG. 4 or like processes are respectively carried out are designated by the same reference characters as those shown in FIG. 4, and the explanation of the steps will be simplified.

In the tunnel display processing, whether the tunnel flag of a link R1 corresponding to the current position has varied from “0” to “1” is checked to see first (step ST21). When it is determined, in this step ST21, that the tunnel flag has not varied from “0” to “1”, it is recognized that the vehicle has not entered a tunnel and the tunnel display processing is ended.

In contrast, when it is determined, in step ST21, that the tunnel flag has varied from “0” to “1”, it is recognized that the vehicle has entered a tunnel and the remaining distance of the current link is then defined as a continuous-tunnels remaining distance D (step ST22). The number of continuous tunnels N is then initialized to “1” (step ST41). More specifically, a navigation processing unit 25 initializes a number-of-tunnels counter (not shown in the figure) for counting the number of tunnels continuously existing at intervals of a predetermined distance or less to “1”. Whether or not the tunnel flag of the link next to the link R1 is “1” is then checked to see (step ST23).

When it is determined, in this step ST23, that the tunnel flag of the link next to the link R1 is “1”, it is recognized that the next link is also a tunnel, and the link length of the next link is added to the current continuous-tunnels remaining distance D and this addition result is defined as a new continuous-tunnels remaining distance D (step ST24). The link next to the link R1 is then defined as a new link R1 (step ST25). After that, the navigation device returns the sequence to step ST23 and then repeats the above-mentioned processing.

When it is determined, in above-mentioned step ST23, that the tunnel flag of the link next to the link R1 is not “1”, i.e. “0”, it is recognized that the next link is not a tunnel, and whether N is equal to or smaller than a predetermined number is then checked to see (step ST42). More specifically, the navigation processing unit 25 checks to see whether or not the count value of the number-of-tunnels counter is equal to or smaller than the predetermined number. When it is determined, in this step ST42, that N is neither equal to nor smaller than the predetermined number, the tunnel display processing is ended.

In contrast, when it is determined, in step ST42, that N is equal to or smaller than the predetermined number, D is then outputted as the continuous-tunnels remaining distance (step ST30). As a result, the remaining distance to the exit of one of the tunnels existing continuously at intervals of the predetermined distances or less is displayed on a part of the screen of a display unit 15. The number of continuous tunnels N is then incremented (+1) (step ST43). More specifically, the navigation processing unit 25 adds “1” to the count value of the number-of-tunnels counter.

Whether a link whose tunnel flag is “1” exists forwardly at the predetermined distance or less from the link next to the link R1 is then checked to see (step ST26). When it is determined, in this step ST26, that a link whose tunnel flag is “1” exists forwardly at the predetermined distance or less from the link next to the link R1, it is recognized that a tunnel exists continuously at intervals of the predetermined distance or less, and this link next to the link R1 is defined as a new link R1 (step ST27). The process in this step ST27 is the same as that in above-mentioned step ST25. The link length of the next link is then added to the current continuous-tunnels remaining distance D and this addition result is defined as a new continuous-tunnels remaining distance D (step ST28). The process in this step ST28 is the same as that in above-mentioned step ST24.

Whether the tunnel flag of the link next to the link R1 is “0” is then checked to see (step ST29). When it is determined, in this step ST29, that the tunnel flag of the link next to the link R1 is “0”, the navigation device returns the sequence to step ST27 and repeats the above-mentioned processing. In contrast, when it is determined, in step ST29, that the tunnel flag of the link next to the link R1 is not “0”, the navigation device returns the sequence to step ST23 and repeats the above-mentioned processing.

When it is determined, in above-mentioned step ST26, that no link whose tunnel flag is “1” exists forwardly at the predetermined distance or less from the link next to the link R1, it is recognized that no more tunnel exists continuously at intervals of the predetermined distance or less, and the tunnel display processing is ended.

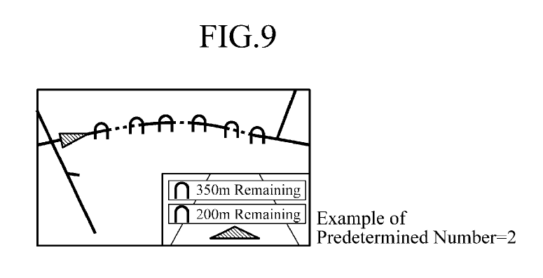

Through the above-mentioned processing, when a plurality of tunnels exist continuously at intervals of the predetermined distances or less, the distance to the exit of each of a predetermined number of tunnels is displayed on a part of the screen of the display unit 15, as shown in FIG. 9, for example. FIG. 9 shows an example in which the distances to the exits of two tunnels closer to the current position are shown by character strings: “200 m remaining” and “350 m remaining”, respectively. The navigation device can be constructed in such a way as to output, by voice, the remaining distance to the exit of each of the predetermined number of tunnels existing continuously at intervals of the predetermined distances or less in addition to the above-mentioned display. In this case, an output control unit 26 generates a voice signal for saying the remaining distance to the exit of each of the predetermined number of tunnels existing continuously at intervals of the predetermined distances or less according to the continuous-tunnels remaining distance D received from a control unit 27, and sends the voice signal to a voice output unit 16.

As explained above, because when the vehicle has entered a tunnel, the map information processing device in accordance with Embodiment 4 of the present invention displays the distance to the exit of each of a predetermined number of tunnels existing continuously at intervals of the predetermined distance or less, the psychological burden on the driver resulting from being unable to acquire any information about tunnel exits can be reduced. Furthermore, because the number of tunnels for each of which the distance to the exit of the tunnel is displayed on the screen is limited to the predetermined number, the display of the screen can be prevented from becoming complicated when many tunnels exist continuously at intervals of the predetermined distance or less.

### Embodiment 5

A map information processing device in accordance with Embodiment 5 of the present invention is constructed in such a way as to display the distance to the exit of the last one of tunnels while displaying the distance to the exit of each of the tunnels until the number of points at each of which a tunnel flag varies from “1” to “0” reaches a predetermined number. The map information processing device in accordance with Embodiment 4 of the present invention has the same structure as that in accordance with Embodiment 1 shown in FIG. 1.

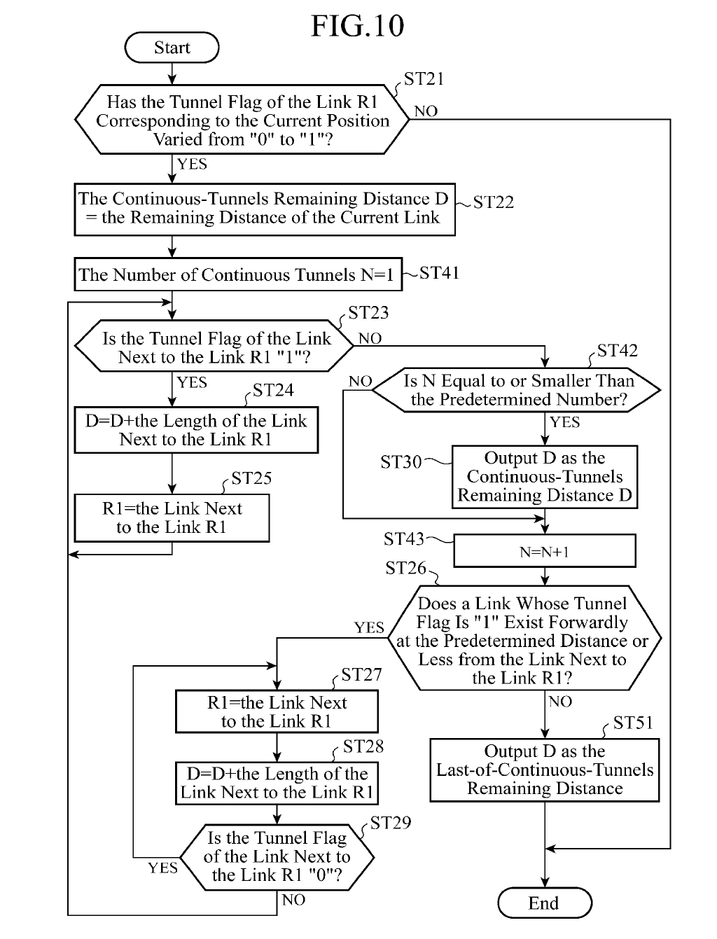

Next, the operation of the map information processing device in accordance with Embodiment 5 will be explained with reference to a flow chart shown in FIG. 10, focusing on tunnel display processing of displaying information about tunnel exits. Steps in which the same processes as those of the tunnel display processing carried out by the map information processing device in accordance with Embodiment 4 shown in the flowchart of FIG. 8 or like processes are respectively carried out are designated by the same reference characters as those shown in FIG. 8, and the explanation of the steps will be simplified.

In the tunnel display processing, whether the tunnel flag of a link R1 corresponding to the current position has varied from “0” to “1” is checked to see first (step ST21). When it is determined, in this step ST21, that the tunnel flag has not varied from “0” to “1”, it is recognized that the vehicle has not entered a tunnel and the tunnel display processing is ended.

In contrast, when it is determined, in step ST21, that the tunnel flag has varied from “0” to “1”, it is recognized that the vehicle has entered a tunnel and the remaining distance of the current link is then defined as a continuous-tunnels remaining distance D (step ST22). The number of continuous tunnels N is then initialized to “1” (step ST41). Whether or not the tunnel flag of the link next to the link R1 is “1” is then checked to see (step ST23).

When it is determined, in this step ST23, that the tunnel flag of the link next to the link R1 is “1”, it is recognized that the next link is also a tunnel, and the link length of the next link is added to the current continuous-tunnels remaining distance D and this addition result is defined as a new continuous-tunnels remaining distance D (step ST24). The link next to the link R1 is then defined as a new link R1 (step ST25). After that, the navigation device returns the sequence to step ST23 and then repeats the above-mentioned processing.

When it is determined, in above-mentioned step ST23, that the tunnel flag of the link next to the link R1 is not “1”, i.e. “0”, it is recognized that the next link is not a tunnel, and whether N is equal to or smaller than a predetermined number is then checked to see (step ST42). More specifically, a navigation processing unit 25 checks to see whether or not the count value of a number-of-tunnels counter is equal to or smaller than the predetermined number. When it is determined, in this step ST42, that N is neither equal to nor smaller than the predetermined number, the navigation device advances the sequence to step ST43.

In contrast, when it is determined, in step ST42, that N is equal to or smaller than the predetermined number, D is then outputted as the continuous-tunnels remaining distance (step ST30). After that, the navigation device advances the sequence to step ST43. In step ST43, the number of continuous tunnels N is then incremented (+1).

Whether a link whose tunnel flag is “1” exists forwardly at the predetermined distance or less from the link next to the link R1 is then checked to see (step ST26). When it is determined, in this step ST26, that a link whose tunnel flag is “1” exists forwardly at the predetermined distance or less from the link next to the link R1, it is recognized that a tunnel exists continuously at intervals of the predetermined distance or less, and this link next to the link R1 is defined as a new link R1 (step ST27). The process in this step ST27 is the same as that in above-mentioned step ST25. The link length of the next link is then added to the current continuous-tunnels remaining distance D and this addition result is defined as a new continuous-tunnels remaining distance D (step ST28). The process in this step ST28 is the same as that in above-mentioned step ST24.

Whether the tunnel flag of the link next to the link R1 is “0” is then checked to see (step ST29). When it is determined, in this step ST29, that the tunnel flag of the link next to the link R1 is “0”, the navigation device returns the sequence to step ST27 and repeats the above-mentioned processing. In contrast, when it is determined, in step ST29, that the tunnel flag of the link next to the link R1 is not “0”, the navigation device returns the sequence to step ST23 and repeats the above-mentioned processing.

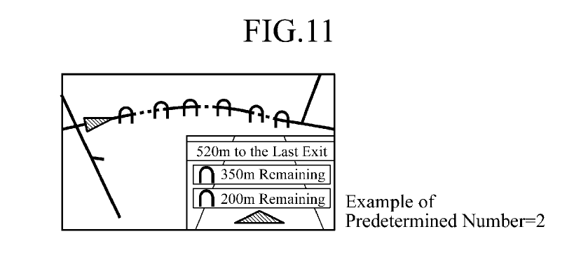

When it is determined, in above-mentioned step ST26, that no link whose tunnel flag is “1” exists forwardly at the predetermined distance or less from the link next to the link R1, it is recognized that no more tunnel exists continuously at intervals of the predetermined distance or less, and D is outputted as the last-of-continuous-tunnels remaining distance (step ST51). More specifically, the navigation processing unit 25 defines the count value of a tunnel distance counter at that time as the last-of-continuous-tunnels remaining distance D, and informs this distance to an output control unit 26 via a control unit 27. The output control unit 26 generates an image in which the last-of-continuous-tunnels remaining distance D received from the control unit 27 is superimposed onto a map, and sends the image to a display unit 15 as an image signal. As a result, as shown in FIG. 11, for example, in addition to character strings: “200 m remaining” and “350 m remaining” as displayed in FIG. 9 by the map information processing device in accordance with Embodiment 4, the remaining distance to the exit of the last tunnel (“520 m remaining to the exit of the last tunnel”) among the tunnels existing continuously at intervals of the predetermined distance or less is displayed on a part of the screen of the display unit 15. After that, the tunnel display processing is ended.

The navigation device can be constructed in such a way as to output, by voice, the remaining distance to the exit of each of a predetermined number of tunnels existing continuously at intervals of the predetermined distance or less in addition to the above-mentioned display. In this case, the output control unit 26 generates a voice signal for saying the remaining distance to the exit of each of the predetermined number of tunnels existing continuously at intervals of the predetermined distance or less according to the continuous-tunnels remaining distance D received from the control unit 27, and sends the voice signal to a voice output unit 16.

As explained above, because when the vehicle has entered a tunnel, the map information processing device in accordance with Embodiment 5 of the present invention displays the distance to the exit of each of a predetermined number of closer tunnels existing continuously at intervals of the predetermined distance or less and the remaining distance to the exit of the last one of the tunnels, the psychological burden on the driver resulting from being unable to acquire any information about tunnel exits can be reduced.

### INDUSTRIAL APPLICABILITY

Because the map information processing device in accordance with the present invention can reduce the psychological burden on the driver resulting from being unable to acquire any information about tunnel exits, the map information processing device in accordance with the present invention is suitable for use as a map information processing device for processing map information which is applied to a navigation device and so on, and which presents information about tunnel exits when the vehicle is traveling through a plurality of continuous tunnels, for example.

1. A map information processing device comprising:
a map information storage unit for storing map information;
a sensor information input unit for inputting sensor information used for calculation of a current position;
a navigation processing unit for calculating the current position by using the map information read from said map information storage unit, and the sensor information inputted from said sensor information input unit, and for, when determining, from said calculated current position, that a vehicle has entered a tunnel shown by said read map information, calculating a number of tunnels excising forwardly and continuously at intervals of a predetermined distance or less from said tunnel to generate a map image about a map including said calculated number of tunnels; and
an output control unit for outputting the map image generated by said navigation processing unit.

2. A map information processing device comprising:
a map information storage unit for storing map information;
a sensor information input unit for inputting sensor information used for calculation of a current position;
a navigation processing unit for calculating the current position by using the map information read from said map information storage unit, and the sensor information inputted from said sensor information input unit, and for, when determining, from said calculated current position, that a vehicle has entered a tunnel shown by said read map information, calculating a remaining distance to an exit of a last one of tunnels excising forwardly and continuously at intervals of a predetermined distance or less from said tunnel to generate a map image about a map including said calculated remaining distance; and
an output control unit for outputting the map image generated by said navigation processing unit.

3. A map information processing device comprising:
a map information storage unit for storing map information;
a sensor information input unit for inputting sensor information used for calculation of a current position;
a navigation processing unit for calculating the current position by using the map information read from said map information storage unit, and the sensor information inputted from said sensor information input unit, and for, when determining, from said calculated current position, that a vehicle has entered a tunnel shown by said read map information, calculating a remaining distance to an exit of each of all tunnels excising forwardly and continuously at intervals of a predetermined distance or less from said tunnel to generate a map image about a map including said calculated remaining distance; and
an output control unit for outputting the map image generated by said navigation processing unit.

4. A map information processing device comprising:
a map information storage unit for storing map information;
a sensor information input unit for inputting sensor information used for calculation of a current position;
a navigation processing unit for calculating the current position by using the map information read from said map information storage unit, and the sensor information inputted from said sensor information input unit, and for, when determining, from said calculated current position, that a vehicle has entered a tunnel shown by said read map information, calculating a remaining distance to an exit of each of a predetermined number of tunnels closer to said current position among all tunnels excising forwardly and continuously at intervals of a predetermined distance or less from said tunnel to generate a map image about a map including said calculated remaining distance; and
an output control unit for outputting the map image generated by said navigation processing unit.

5. A map information processing device comprising:
a map information storage unit for storing map information;
a sensor information input unit for inputting sensor information used for calculation of a current position;
a navigation processing unit for calculating the current position by using the map information read from said map information storage unit, and the sensor information inputted from said sensor information input unit, and for, when determining, from said calculated current position, that a vehicle has entered a tunnel shown by said read map information, calculating a remaining distance to an exit of each of a predetermined number of tunnels closer to said current position among all tunnels excising forwardly and continuously at intervals of a predetermined distance or less from said tunnel and a remaining distance to an exit of a last one of all the tunnels to generate a map image about a map including said calculated remaining distances; and
an output control unit for outputting the map image generated by said navigation processing unit.
